(19) United States
(12) Patent Application Publication
(10) Pub. No.: US 2015/0279197 A1
(43) Pub. Date: Oct. 1, 2015

(54) Method for Contacting Help Services

(71) Applicant: Steve M. Said, Naples, FL (US)

(72) Inventor: Steve M. Said, Naples, FL (US)

(21) Appl. No.: 14/542,075

(22) Filed: Nov. 14, 2014

Related U.S. Application Data
(60) Provisional application No. 61/972,925, filed on Mar. 31, 2014.

(51) Int. Cl. G08B 25/01; G08B 21/02

(52) U.S. Cl. CPC G08B 25/016; G08B 21/02

(57) ABSTRACT

A method for contacting help services through a self-contained multi-platform software program run on an electronic device. An emergency alert request is received from a user input through the electronic device, a transmitter of a secondary device communicably coupled to the electronic device, or a sensor of the electronic device. The user input can be either a tactile input or audible input depending on the capabilities of the electronic device or the secondary device. Location data is then retrieved from a user account or a positioning receiver of the electronic device. The positioning receiver can retrieve subsequent location data if the electronic device is relocated. The emergency alert request and the location data are then used to generate an emergency alert message. The emergency alert message is then sent to a help service account as either a textual or audible message, wherein the contacted help service can then respond accordingly.

The current application claims a priority to the U.S. Provisional patent application Ser. No. 61/972,925 filed on Mar. 31, 2014.

### FIELD OF THE INVENTION

The present invention relates generally to help service software applications. More specifically, the present invention is a software program for requesting help from police, fire, ambulance, or family and friends, upon activation from user input or monitoring sensors.

### BACKGROUND OF THE INVENTION

In emergency situations time and communication with help services is paramount. In many emergency situations it is imperative to the well being of the victim for help services to act fast, particularly in the case of fires and medical situations. While many cities have established emergency response systems and teams, there are still many cities lacking in emergency response infrastructure. As a result, many emergency situations of which the severity could much lessened occur due to lack of communications with help services, inaccessibility to contact help services, or insufficient help service infrastructure.

In other emergencies it is beneficial to establish either one way or two way communications with a help service. For example, in the event of a kidnapping it would be beneficial to supply constant location data for tracking a victim in addition to providing video or audio feed of the event as it unfolds. In other situations, such as in a fire or medical situation, it is beneficial to establish two way communication, wherein the help service can provide instructions to the victim or someone with the victim, and receive feedback in order to provide better instructions until the individuals from the help service can arrive. Such feedback and communications can be the difference between life and death in many situations.

Therefore it is the object of the present invention to provide a method for contacting help services through a self-contained multi-platform software program. The present invention allows a user to initiate an emergency alert request in the event of an emergency. Upon initiation of the emergency alert request, location data is retrieved for the electronic device on which the software program is being operated. The location data can be stored within a user account or retrieved from a positioning receiver in the electronic device. An emergency alert message is then generated from the emergency alert request and the location data, and is sent to a help service account, such that the designated help service can assist the victim. Initiation of the emergency alert request may also activate components of the electronic device, such as a microphone, speaker, or camera, in order to gather data and establish communication between the victim and the help service.

### BRIEF DESCRIPTION OF THE DRAWINGS

FIG. 1 is a flowchart showing the process for generating an emergency alert message on an electronic device to send to a help service account;

FIG. 2 is a flowchart thereof, depicting an emergency alert request being received from a user input;

FIG. 3 is a flowchart thereof, depicting the emergency alert request being received from a transmitter within a secondary device communicably coupled to the electronic device;

FIG. 4 is a flowchart thereof, depicting the emergency alert request being received from a sensor of the electronic device;

FIG. 5 is a flowchart thereof, depicting location data being retrieved from a user account;

FIG. 6 is a flowchart thereof, depicting the location data being retrieved from a positioning receiver of the electronic device, wherein subsequent location data can also be retrieved and sent to the help service account;

FIG. 7 is a flowchart thereof, depicting the activation of other electronic device components that can aide a user or help service in an emergency situation; and

FIG. 8 is a flowchart thereof, depicting a pre-recorded video being retrieved and uploaded to a social media website during an emergency situation.

### DETAIL DESCRIPTIONS OF THE INVENTION

All illustrations of the drawings are for the purpose of describing selected versions of the present invention and are not intended to limit the scope of the present invention.

The present invention is a method for contacting help services through a self-contained multi-platform software program. The software program is loaded onto an electronic device 10, wherein upon activation of the software program or a function within the software program, a request for help is sent to police, fire rescue, paramedics, family, or friends. The specific destination to which the request for help is sent is dependent on the settings of the software program or on the type of emergency detected by the software program. It is possible for a user to change the setting of the software program through a user account 60, such that the user can define contacts for family, friends, local help services, etc.

The software program through which the method of the present invention is carried out can be installed on any type of electronic device. In the preferred embodiment of the present invention the software program is installed on a portable electronic device, such as a smartphone or tablet. However, the software program can also be utilized with desktops, point of service stations, or any other computing devices. The only requirement for the electronic device 10 is that the electronic device 10 is capable of establishing a communicable connection with the help services, whether it is through a wired connection or wireless connection.

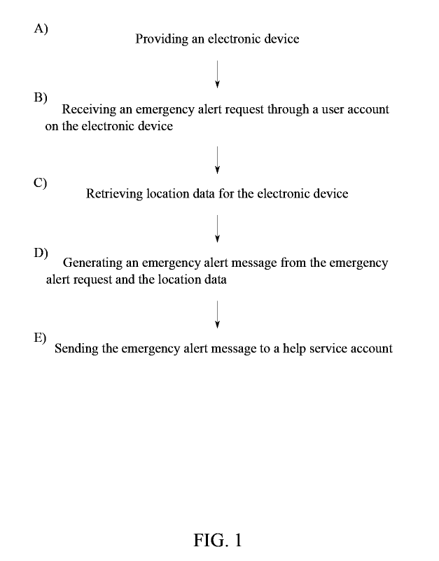

In reference to FIG. 1, the user account 60 links the electronic device 10 to the user, such that personal information for the user is stored under the user account 60 and can be forwarded to help services in the event of an emergency. As such, the user account 60 is always active on the electronic device 10 through the software program, wherein interaction with the software program is made through the user account 60. In the case of an emergency, an emergency alert request 30 is initiated by the user through the user account 60 on the electronic device 10. The emergency alert request 30 initiates processes within the software program for collecting data and for contacting help services.

The emergency alert request 30 can be initiated by the user in multiple ways depending on the available functions of the electronic device 10. Additionally, the emergency alert request 30 can be initiated directly or indirectly through the electronic device 10. The emergency alert request 30 can be directly received by the electronic device 10 through a user input 80 or from a sensor 12 integrated into the electronic device 10, wherein the sensor 12 is designed to monitor one or more measures of the surrounding environment of the electronic device 10. A secondary device 20, communicably coupled to the electronic device 10, is used when the emergency alert request 30 for the electronic device 10 is indirectly initiated.

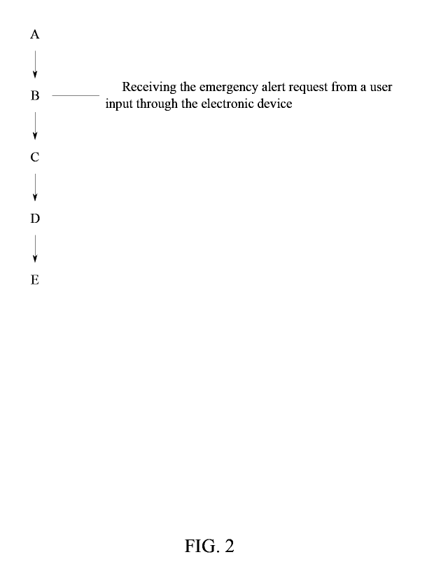

In reference to FIG. 2, when the emergency alert request 30 is received from the user input 80 through the electronic device 10, the user input 80 can be either a tactile input or an audible input. The tactile input can be processed in many forms depending on the functionality of the electronic device 10. For example, if the electronic device 10 is a smartphone, then the tactile input would be processed through touch screen controls or buttons on the smartphone, while the audible input would be processed through the microphone of the smartphone. Tactile inputs through a touch screen can encompass single touches, swipes, and multiple location touches, while tactile inputs through buttons may include single or multiple push and hold buttons. Other tactile inputs include keyboard entries, mouse clicks, etc.

The user input 80 can be made directly through the software program or while the software program is running in the background, depending on the settings of the software program. For example, the user may need to first open the software program in order to enter the tactile input or the audible input through the software program. Alternatively, if the software program is running in the background, then the emergency alert request 30 can be made through a specific series of user inputs being of the tactile input and/or audible input nature. For example, pressing and holding a specific set of buttons on the electronic device 10 may automatically initiate the emergency alert request 30, or may initiate the process for providing the audible input. The audible input may also be used to record an audio message that can be incorporated into the emergency alert request 30 to be sent to the specified help services.

The software program can also be run in the background when the electronic device 10 is turned “off”. The electronic device 10 is run in a low power mode, wherein the software program can continue to run and monitor user inputs, while other options and functions of the electronic device 10 are disabled. In such a state, the electronic device 10 is powered either by an internal or external battery power source.

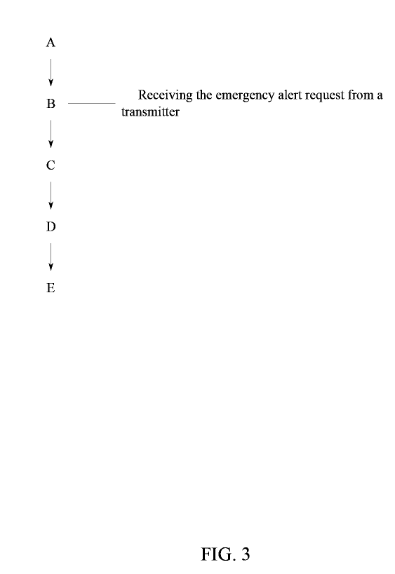

In reference to FIG. 3, when the emergency alert request 30 is indirectly initiated, the user input 80 is processed through the secondary device 20. Once the user input 80 is processed by the secondary device 20, the secondary device 20 generates a signal for the emergency alert request 30. The signal for the emergency alert request 30 is then sent wirelessly to the electronic device 10 via a transmitter 21 of the secondary device 20. Any type of wireless protocol may be used by the electronic device 10 and the transmitter 21. The user input 80 through the secondary device 20 can be of either the tactile input or audible input nature.

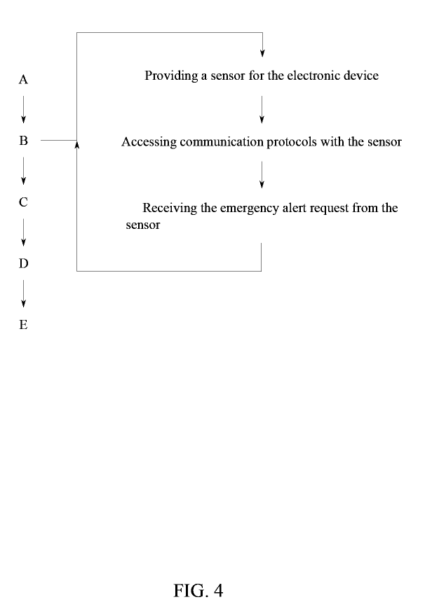

In reference to FIG. 4, if the electronic device 10 is equipped with the sensor 12, then the user input 80 is not required to initiate the emergency alert request 30 in certain situations. When the software program is installed on the electronic device 10, communication protocols with the sensor 12 are accessed and established, such that the sensor 12 is used to constantly monitor designated events or states and communicate any sensory inputs to the software program. The sensor 12 can be configured to monitor a number of different surrounding environment factors and the current state of the electronic device 10. The sensor 12 can be positioned internally or externally on the electronic device 10, depending on the design of the sensor 12 and the desired functionality of the sensor 12.

In one embodiment of the present invention, the sensor 12 provides a wet function option, wherein the sensor 12 can detect wetness. Once a certain wetness threshold is reached, the sensor 12 will send a signal to attempt to initiate the emergency alert request 30 before the electronic device 10 is terminally damaged.

In another embodiment of the present invention, the sensor 12 provides a smashed function option, wherein the sensor 12 can detect physical damage to the electronic device 10, such as the screen or casing being broken, crushed, etc. Once damage to the electronic device 10 is detected, the sensor 12 will send a signal to attempt to initiate the emergency alert request 30 before the electronic device 10 is terminally damaged.

In yet another embodiment of the present invention, the sensor 12 provides a tamper function option, wherein the sensor 12 can detect any tampering with the electronic device 10, either software or hardware. Once unwarranted tampering with the electronic device 10 is detected, the sensor 12 will send a signal to attempt to initiate the emergency alert request 30 before the electronic device 10 is terminally damaged.

In another embodiment of the present invention, the sensor 12 is designed to measure human vitals, such as pulse, body temperature, etc. Once the sensor 12 detects the vitals of the user to be within a certain threshold, the sensor 12 sends a signal to initiate the emergency alert request 30 to send help for an ambulance. The sensor 12 may be integrated into the electronic device 10 or the secondary device 20, wherein the electronic device 10 or the secondary device 20 may be worn by the user.

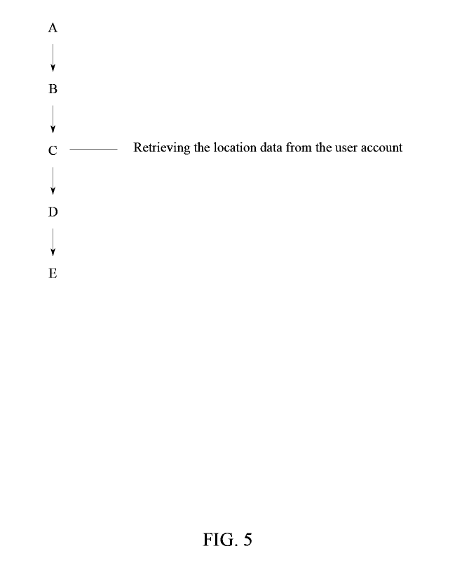

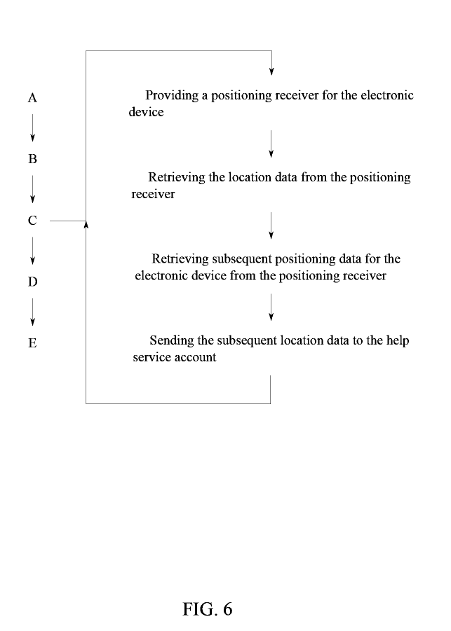

In reference to FIG. 1, once the emergency alert request 30 has been received, the location data 40 for the electronic device 10 is retrieved. The location data 40 can be retrieved in one of two ways; either from the user account 60, as depicted in FIG. 5, or from a positioning receiver 11 in the electronic device 10, as depicted in FIG. 6. Location data 40 for the global position of the electronic device 10 can be entered into the user account 60 by the user. Location data 40 stored in the user account 60 is ideal for stationary devices, such as desktop computers, servers, etc., which are unlikely to change global positions. On the other hand, retrieving the location data 40 from the positioning receiver 11 is ideal for mobile devices, as such devices have ever changing global positions.

In further reference to FIG. 1, once the emergency alert request 30 is received and the location data 40 for the electronic device 10 is retrieved, an emergency alert message 50 is generated from the emergency alert request 30 and the location data 40. The emergency alert message 50 is then sent to a help service account 70 for the desired help service. Depending on the functionality of the electronic device 10 and the system capabilities through which the help service account 70 is provided, the emergency alert message 50 may be either a textual message or an audible message. Textual messages can be sent via email, short message service, or any other communication protocol. Audible messages may be recorded or live streamed to the help service account 70. It is also possible for text to audio messages to be sent to the help service account 70 if the capabilities of the help service allow such functionality.

In reference to FIG. 6, when using the positioning receiver 11, the location data 40 is for the initial location at which the emergency alert request 30 was made. If the electronic device 10 then changes location following the emergency alert request 30, then subsequent location data 41 for the electronic device 10 is retrieved from the positioning receiver 11. The subsequent location data 41 is then sent to the help service account 70, such that the help service can track the user of the electronic device 10 and provide proper service to the correct location. The positioning receiver 11 can be configured to work with the Global Positioning System (GPS), or with any other standard positioning system.

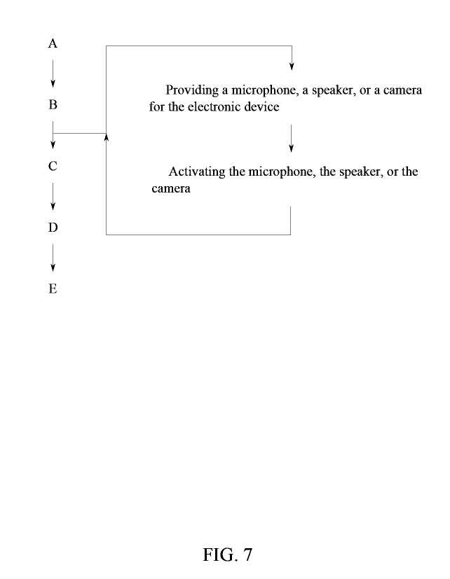

In reference to FIG. 7, upon receiving the emergency alert request 30, the software program may activate other components of the electronic device 10, such as a microphone 13, a speaker 14, or a camera 15. These components of the electronic device 10 can allow information from the current emergency situation to be relayed to the help service account 70 and allows the help service to better communicate with the user throughout the emergency situation. This is very beneficial in many emergency situations, such as a kidnapping, a home invasion, being trapped in a burning building, or not being able to move in a medical emergency.

The microphone 13 captures audio data that is then relayed to the help service account 70. The microphone 13 can be used to record a single instance of sound or a constant live stream of audio depending on settings within the software program. Similarly, the camera 15 is used to capture visual data that is then relayed to the help service account 70. The camera 15 can be used to capture still images, record a brief instance, or provide a constant live stream of video depending on the capabilities of the electronic device 10 and the settings within the software program. The speaker 14 allows the help service to communicate directly with the user, wherein the help service can provide instructions to the user in an attempt to help the user through the emergency situation.

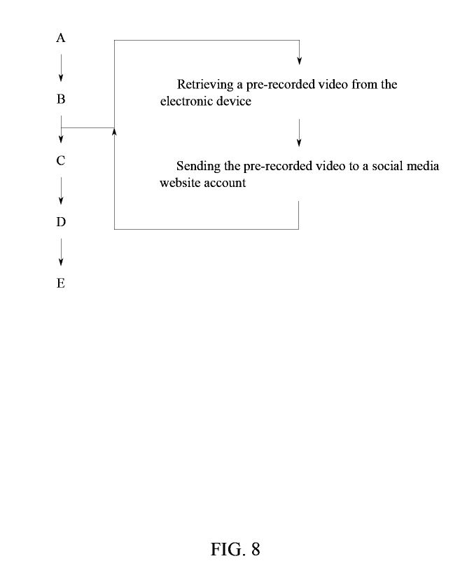

In reference to FIG. 8, it is also possible for the user to store pre-recorded video 90 on the electronic device 10 that is accessible to the software program. When the emergency alert request 30 is received, the pre-recorded video 90 is retrieved from the electronic device 10. The pre-recorded video 90 can also be stored on the secondary device 20 or any other device communicably coupled to the electronic device 10, wherein the pre-recorded video 90 is accessible through the electronic device 10. Once the pre-recorded video 90 is retrieved, the pre-recorded video 90 is sent to a social media website account, wherein the pre-recorded video 90 is visible on the social media website through which the social media website account is hosted.

Although the invention has been explained in relation to its preferred embodiment, it is to be understood that many other possible modifications and variations can be made without departing from the spirit and scope of the invention as hereinafter claimed.

What is claimed is:

1. A method for contacting help services by executing computer-executable instructions stored on a non-transitory computer-readable medium, the method comprises the steps of:
providing an electronic device;
receiving an emergency alert request through a user account on the electronic device;
retrieving location data for the electronic device;
generating an emergency alert message from the emergency alert request and the location data; and
sending the emergency alert message to a help service account.

2. The method for contacting help services by executing computer-executable instructions stored on a non-transitory computer-readable medium, the method as claimed in claim 1 further comprises the steps of:
retrieving the location data from the user account.

3. The method for contacting help services by executing computer-executable instructions stored on a non-transitory computer-readable medium, the method as claimed in claim 1 further comprises the steps of:
providing a positioning receiver for the electronic device, wherein the positioning receiver collects the location data; and
retrieving the location data from the positioning receiver.

4. The method for contacting help services by executing computer-executable instructions stored on a non-transitory computer-readable medium, the method as claimed in claim 3 further comprises the steps of:
retrieving subsequent location data for the electronic device from the positioning receiver; and
sending the subsequent location data to the help service account.

5. The method for contacting help services by executing computer-executable instructions stored on a non-transitory computer-readable medium, the method as claimed in claim 1 further comprises the steps of:
receiving the emergency alert request from a user input through the electronic device.

6. The method for contacting help services by executing computer-executable instructions stored on a non-transitory computer-readable medium, the method as claimed in claim 5, wherein the user input is an audible input.

7. The method for contacting help services by executing computer-executable instructions stored on a non-transitory computer-readable medium, the method as claimed in claim 5, wherein the user input is a tactile input.

8. The method for contacting help services by executing computer-executable instructions stored on a non-transitory computer-readable medium, the method as claimed in claim 1 further comprises the steps of:
receiving the emergency alert request from a transmitter.

9. The method for contacting help services by executing computer-executable instructions stored on a non-transitory computer-readable medium, the method as claimed in claim 1 further comprises the steps of:
providing a sensor for the electronic device; and
accessing communication protocols with the sensor.

10. The method for contacting help services by executing computer-executable instructions stored on a non-transitory computer-readable medium, the method as claimed in claim 9 further comprises the steps of:
receiving the emergency alert request from the sensor.

11. The method for contacting help services by executing computer-executable instructions stored on a non-transitory computer-readable medium, the method as claimed in claim 10, wherein the at least one sensor can detect wetness.

12. The method for contacting help services by executing computer-executable instructions stored on a non-transitory computer-readable medium, the method as claimed in claim 10, wherein the at least one sensor can detect damage to the electronic device.

13. The method for contacting help services by executing computer-executable instructions stored on a non-transitory computer-readable medium, the method as claimed in claim 10, wherein the at least one sensor can detect tampering with the electronic device.

14. The method for contacting help services by executing computer-executable instructions stored on a non-transitory computer-readable medium, the method as claimed in claim 10, wherein the at least one sensor can monitor human vital signs.

15. The method for contacting help services by executing computer-executable instructions stored on a non-transitory computer-readable medium, the method as claimed in claim 1, wherein the emergency alert message is an audible message.

16. The method for contacting help services by executing computer-executable instructions stored on a non-transitory computer-readable medium, the method as claimed in claim 1, wherein the emergency alert message is a textual message.

17. The method for contacting help services by executing computer-executable instructions stored on a non-transitory computer-readable medium, the method as claimed in claim 1 further comprises the steps of:
retrieving a pre-recorded video from the electronic device; and
sending the pre-recorded video to a social media website account.

18. The method for contacting help service by executing computer-executable instructions stored on a non-transitory computer-readable medium, the method as claimed in claim 1 further comprises the steps of:
providing a microphone for the electronic device; and
activating the microphone in order to collect audio data.

19. The method for contacting help service by executing computer-executable instructions stored on a non-transitory computer-readable medium, the method as claimed in claim 1 further comprises the steps of:
providing a speaker for the electronic device; and
activating the speaker in order to communicate through the electronic device.

20. The method for contacting help service by executing computer-executable instructions stored on a non-transitory computer-readable medium, the method as claimed in claim 1 further comprises the steps of:
providing a camera for the electronic device; and
activating the camera in order to collect visual data.
